(19) United States
(12) Patent Application Publication
(10) Pub. No.: US 2004/0084134 A1
(43) Pub. Date: May 6, 2004

(54) Process for producing non-woven composite fabric by water-jet entangling, and non-woven composite fabric product including the non-woven composite fabric

(76) Inventor: Jung Chi Tai, Tainan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/688,540

(22) Filed: Oct. 17, 2003

(30) Foreign Application Priority Data
Oct. 24, 2002 (TW) 91124772

(51) Int. Cl. D04H 3/10; D04H 1/56; B32B 7/08; B32B 5/26; D04H 5/00; D04H 1/00; B32B 5/00; B32B 29/02

(52) U.S. Cl. 156/176; 428/904; 442/408; 442/382; 442/384; 442/387; 442/400; 442/401; 156/148

(57) ABSTRACT

A process for producing a non-woven composite fabric by water-jet entangling. First, at least two webs are formed. These at least two webs include at least one spunbonded web or meltblown web. Then, the at least two webs are consolidated by water-jet entangling into a non-woven composite fabric. Compared to a conventional process using thermal bonding to consolidate webs, since the present invention uses water-jet entangling to consolidate webs, the non-woven composite fabric produced from the present invention has superior softness. In addition, the non-woven composite fabric produced from the present invention can be further processed to produce various non-woven composite fabric products such as disposable diapers, sanitary napkins, panty liners, and artificial leather, all with superior softness.

### BACKGROUND OF THE INVENTION

1. Field of the Invention

The present invention relates to a process for producing a non-woven composite fabric, and more particularly to a process for producing a non-woven composite fabric using water-jet entangling to consolidate webs.

2. Description of the Prior Art

Non-woven fabrics have been extensively used in household and medical applications, including disposable diapers, sanitary napkins, and surgical clothes. Generally, a non-woven fabric is formed by consolidating multiple layers of different webs. For example, R.O.C. Patent Publication No. 375664 discloses a spunbonded-meltblown non-woven composite fabric, produced by consolidating a spunbonded web, at least one meltblown web, and a spunbonded web by thermal bonding. However, the non-woven composite fabric obtained has inferior softness, which cannot meet the requirements of some products.

### SUMMARY OF THE INVENTION

An object of the present invention is to solve the above-mentioned problems and provide a process for producing a non-woven composite fabric with superior softness.

Another object of the present invention is to provide a process for producing a non-woven composite fabric, in which the steps of forming webs and consolidating webs are conducted on the same production line, simplifying the process and saving costs.

Another object of the present invention is to provide a non-woven composite fabric with superior softness.

A further object of the present invention is to provide a non-woven composite fabric product with good softness.

To achieve the above objects, the present invention uses water-jet entangling to produce a non-woven composite fabric. The process includes the following steps. First, at least two webs are formed, including at least one spunbonded web or meltblown web. The webs are then consolidated by water-jet entangling into a non-woven composite fabric.

According to a preferred embodiment of the present invention, the at least two webs include a spunbonded web and a meltblown web.

According to another preferred embodiment of the present invention, the at least two webs include a spunbonded web, a meltblown web, and a carded web.

According to another preferred embodiment of the present invention, formation of the webs and the water-jet entangling step are conducted or the same production line.

According to a further preferred embodiment of the present invention, after water-jet entangling, a step of coating with or dipping in polyurethane (PU) can be further conducted.

Compared to a conventional process using thermal bonding to consolidate webs, since the present invention uses water-jet entangling to consolidate webs, the non-woven composite fabric produced from the present invention has superior softness. In addition, the non-woven composite fabric produced from the present invention can be further processed to produce various non-woven composite fabric products such as disposable diapers, sanitary napkins, panty liners, and artificial leather, all with superior softness.

### DETAILED DESCRIPTION OF THE INVENTION

The present invention provides a process for producing a non-woven composite fabric, including the following steps. First, at least two webs are formed, including at least one spunbonded web or meltblown web. Then, the webs are consolidated by water-jet entangling into a non-woven composite fabric.

The main feature of the present invention is to use water-jet entangling to consolidate webs, improving softness of the obtained non-woven composite fabric. The webs used in the present invention include at least two webs, with at least one web is a spunbonded or a meltblown web.

Therefore, the non-woven composite fabric of the present invention can have various combinations. According to a preferred embodiment of the present invention, the webs in the non-woven composite fabric can be a combination of any two layers or any three layers of a spunbonded web (abbreviated to “S”) and a meltblown web (abbreviated to “M”). For example, the non-woven composite fabric of the present invention can include two spunbonded webs, forming an SS non-woven fabric. Further, the non-woven composite fabric of the present invention can include a spunbonded web and a meltblown web on the spunbonded web, forming an SM non-woven fabric. Further, the non-woven composite fabric of the present invention can include a meltblown web, and a spunbonded web on the meltblown web, forming an MS non-woven fabric. Further, the non-woven composite fabric of the present invention can include a first spunbonded web, a meltblown web on the first spunbonded web, and a second spunbonded web on the meltblown web, forming an SMS non-woven fabric. Further, the non-woven composite fabric of the present invention can include four webs, including a first spunbonded web, a first meltblown web on the first spunbonded web, a second meltblown web on the first meltblown web, and a second spunbonded web on the second meltblown web, forming an SMMS non-woven fabric.

In addition, the non-woven composite fabric of the present invention can include a spunbonded web, a meltblown web on the spunbonded web, and a carded web (abbreviated to “C”) on the meltblown web, forming an SMC non-woven fabric.

According to the present invention, the spunbonded web can be composed of mono-component fiber or bi-component fiber of a melt spinning polymer. Also, the meltblown web can be composed of mono-component fiber or bi-component fiber of a melt spinning polymer.

Suitable melt spinning polymer can be polypropylene (PP), polyethylene (PE), polyethylene terephthalate (PET), polybutylene terephthalate (PBT), a copolymer of polypropylene (COPP), a copolymer of polyethylene terephthalate (COPET), a copolymer of polybutylene terephthalate (COPBT), or a polyamide. When a bi-component fiber is used, this fiber is preferably made of polypropylene/polyethylene (PP/PE), polyethylene terephthalate/polyethylene (PET/PE), polyethylene terephthalate/polypropylene (PET/PP), polypropylene/a copolymer of polypropylene (PP/COPP), polyethylene terephthalate/a copolymer of polyethylene terephthalate (PET/COPET), or a higher melting polyamide/a lower melting polyamide.

When the fiber of spunbonded web or meltblown web of the present invention is a bi-component fiber, the bi-component of the melt spinning polymer can be made of polypropylene/polyethylene (PP/PE), polyethylene terephthalate/polyethylene (PET/PE), polyethylene terephthalate/polypropylene (PET/PP), polypropylene/a copolymer of polypropylene (PP/CoPP), polyethylene terephthalate/a copolymer of polyethylene terephthalate (PET/CoPET), or a higher melting polyamide/a lower melting polyamide.

The bi-component fiber of the melt spinning polymer can include a lower melting component and a higher melting component. At that time, the fiber can be of sheath and core type or side by side type.

Alternatively, the bi-component fiber can be a micro fiber, such as split type micro fiber or sea and island micro fiber.

In order to simplify the process, the web formation and consolidating (water-jet entangling) can be conducted on the same production line.

The non-woven composite fabric produced from the present invention can be further processed by conventional methods to produce various non-woven composite fabric products such as disposable diapers, sanitary napkins, panty liners, and artificial leather, all with superior softness.

According to the present invention, after conducting water-jet entangling, the surface of the non-woven composite fabric can be coated with polyurethane (PU), or the non-woven composite fabric can be dipped in PU. Then, drying is performed. In this way, the PU-coated composite fabric can be further processed by conventional methods to form artificial leather with superior softness.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A process for producing a non-woven composite fabric, comprising the following steps:
forming at least two webs, wherein the at least two webs include at least one spunbonded web or meltblown web; and
consolidating the at least two webs by water-jet entangling into a non-woven composite fabric.

2. The process as claimed in claim 1, wherein the at least two webs include two spunbonded webs.

3. The process as claimed in claim 1, wherein the at least two webs include a spunbonded web and a meltblown web.

4. The process as claimed in claim 3, wherein the at least two webs include a spunbonded web and a meltblown web on the spunbonded web.

5. The process as claimed in claim 3, wherein the at least two webs include a meltblown web and a spunbonded web on the meltblown web.

6. The process as claimed in claim 1, wherein the at least two webs include a spunbonded web, a meltblown web, and a carded web.

7. The process as claimed in claim 6, wherein the at least two webs include a spunbonded web, a meltblown web on the spunbonded web, and a carded web on the meltblown web.

8. The process as claimed in claim 1, wherein the at least two webs include a first spunbonded web, a meltblown web on the first spunbonded web, and a second spunbonded web on the meltblown web.

9. The process as claimed in claim 1, wherein the at least two webs include a first spunbonded web, a first meltblown web on the first spunbonded web, a second meltblown web on the first meltblown web, and a second spunbonded web on the second meltblown web.

10. The process as claimed in claim 1, wherein the spunbonded web is composed of mono-component fiber or bi-component fiber of a melt spinning polymer, and the meltblown web is composed of mono-component fiber or bi-component fiber of a melt spinning polymer.

11. The process as claimed in claim 10, wherein the melt spinning polymer is polypropylene (PP), polyethylene (PE), polyethylene terephthalate (PET), polybutylene terephthalate (PBT), a copolymer of polypropylene (CoPP), a copolymer of polyethylene terephthalate (CoPET), a copolymer of polybutylene terephthalate (CoPBT), or a polyamide.

12. The process as claimed in claim 10, wherein the bi-component fiber of the melt spinning polymer is made of a material of polypropylene/polyethylene (PP/PE), polyethylene terephthalate/polyethylene (PET/PE), polyethylene terephthalate/polypropylene (PET/PP), polypropylene/a copolymer of polypropylene (PP/CoPP), polyethylene terephthalate/a copolymer of polyethylene terephthalate (PET/CoPET), or a higher melting polyamide/a lower melting polyamide.

13. The process as claimed in claim 7, wherein the bi-component fiber of the melt spinning polymer includes a lower melting component and a higher melting component.

14. The process as claimed in claim 10, wherein the bi-component fiber of the melt spinning polymer is a micro fiber.

15. The process as claimed in claim 1, wherein formation of the at least two webs and the step of water-jet entangling are conducted on the same production line.

16. The process as claimed in claim 1, further comprising, after consolidating, coating with, or dipping in, polyurethane (PU).

17. The process as claimed in claim 16, further comprising, after coating or dipping, drying.

18. A non-woven composite fabric product, comprising the non-woven composite fabric produced by the process of claim 1.

19. The non-woven composite fabric product as claimed in claim 18, wherein the product is a disposable diaper, sanitary napkin, or panty liner.

20. A non-woven composite fabric product, comprising the non-woven composite fabric produced by the process of claim 13.

21. The non-woven composite fabric product as claimed in claim 20, wherein the product is artificial leather.
